(19) United States
(12) Patent Application Publication
(10) Pub. No.: US 2002/0190130 A1
(43) Pub. Date: Dec. 19, 2002

(54) Portable storage device with function for preventing illegal access thereto

(75) Inventor: Yoshimasa Yoshimura, Tokyo (JP)

Correspondence Address: MCDERMOTT, WILL & EMERY, 600 13th Street, N.W., WASHINGTON, DC, 20005-3096, US

(73) Assignee: Mitsubishi Denki Kabushiki Kaisha

(21) Appl. No.: 09/988,174

(22) Filed: Nov. 19, 2001

(30) Foreign Application Priority Data
Jun. 13, 2001 (JP) 2001-178701

(51) Int. Cl. G06K 19/00

(52) U.S. Cl. 235/487

(57) ABSTRACT

A card, which is one of portable storage devices, fills its functions when connected to a terminal device. The card stores a random number table RND. The card calculates a function value f(RND[i]) of a preset function f by setting the argument of the function f as a random number RND[i] corresponding to the index number i which is designated from the random number table RND by the terminal device. Then the card compares and collates the functional value f(RND[i]) with a collating value G which is specially supplied by the terminal device. The card becomes a free state if the function value f(RND[i]) coincides with the collating value G, while it maintains the lock state if the function value f(RND[i]) does not coincide with the collating value G. Then the index number, which has been once used, is excluded in the following comparing or collating operations. In consequence, illegal access to the information stored in the card is surely prevented.

This application is based on the application No. 2001-178701 filed in Japan, the contents of which are hereby incorporated by reference.

### BACKGROUND OF THE INVENTION

1. Field of the Invention

The present invention relates to a portable storage device with a function for preventing illegal access thereto, which is suitable for use to treat extremely confidential data which is not allowed to leak out to outsiders. The present invention can be also applied to a portable storage device such as a removable hard disk device, a PC card ATA using a flash memory card, or the like.

2. Description of the Prior Art

In recent years, a portable storage device such as a removal hard disk device, a PC (personal computer) card ATA (advanced technology attachment) or the like has been broadly used as an external storage device of a terminal device of each of various digital information processing apparatuses (for example, personal computer etc.). Because the portable storage device can be easily taken away from the terminal device and further easily carried anywhere, it has such advantage as to enable data to be easily exchanged among a plurality of terminal devices.

However, the above-mentioned advantage of the portable storage device may be regarded as disadvantage from the point of view to protect the data stored in the portable storage device. That is, illegal access to the data may be easy, because the data stored in a portable storage device such as a removal hard disk device, a PC card ATA or the like can be easily grasped by an outsider, for example if the outsider loads the portable storage device with his own terminal device, or because the data can be easily manipulated by the outsider. Accordingly, in the portable storage device, there exists such a problem that it is not suitable for storing secret data or data whose confidentiality is high.

Thus, there has been proposed, for example such a portable storage device in which the external authentication data sent from a terminal device is compared with the internal authentication data generated in the portable storage device on the basis of an encryption key, a random number or the like, and then the access to the data is enabled when both of the authentication data coincide with each other (see, for example Japanese Laid-open Patent Publication No. 9-179951 or U.S. Pat. No. 6,126,071). However, according to the above-mentioned conventional method of preventing illegal access to the data, it may be possible to decipher the cipher by means of analogical reasoning, or to access the data by inputting a encryption key by means of the round-robin algorithm. Therefore, there exists such a problem that it is impossible to surely prevent illegal access thereto.

### SUMMARY OF THE INVENTION

The present invention, which has been developed to solve the conventional problems described above, has an object to provide a portable storage device which can surely prevent illegal access to the information stored therein.

A portable storage device with a function for preventing illegal access thereto according to the present invention developed to solve the above-mentioned problems, (a) which fills functions thereof when connected to a terminal device, is characterized in that it includes (b) an array storage for storing a random number array RND or RND [ ] (referred to “random number table RND” hereinafter), (c) a calculator for calculating a function value f(RND[i]) of a preset function f by setting an argument of the function f as a random number RND[i] corresponding to an index number which is designated from the random number table RND by the terminal device, and (d) a collator for comparing and collating the function value f(RND[i]) with a collating value G which is supplied by the terminal device.

In the portable storage device according to the present invention, because it is provided with the collator for comparing and collating the function value f(RND[i]) produced in the portable storage device with the collating value G supplied specially from the terminal device, illegal access to the portable storage device may be surely prevented by permitting read access, write access or erase access for the data in the storage device (memory) only when the both values coincide with each other. That is, the portable storage device can be applied for use to store secret information, which should not be disclosed to outsiders or should not be manipulated.

More particularly, in the portable storage device, because the authentication data is produced by performing a secret functional operation for a secret arbitrary value selected from the random table, the outsider which intends to access the storage device, cannot analogize the key in the authentication. Accordingly, it may be prevented that the outsider deciphers the cipher by analogical reasoning to access the storage device illegally. In addition, because it is extremely difficult to access the storage device by inputting an encryption key by the round-robin algorithm, it may be prevented that the storage device is illegally accessed by means of the round-robin algorithm. Hereupon, if the outsider intends to analyze the authentication procedure using a hacking method of monitoring the interface signal to perform the authentication using the same procedure, the outsider will fail the authentication.

In the portable storage device, it is preferable that it initially becomes such a lock state that read access, write access and erase access for the storage device (memory, memory block) are inhibited, after a power source has been turned on, wherein the storage device becomes such a free state that the read access, the write access and the erase access for the storage device are permitted if the function value f(RND[i]) coincides with the collating value G, while the storage device maintains the lock state if the function value f(RND[i]) does not coincide with the collating value G.

In this case, because the portable storage device maintains the lock state if the function value f(RND[i]) does not coincide with the collating value G after the power source has been turned on, illegal access to the portable storage device may be more surely prevented.

In the portable storage device, it is preferable that it further includes an index storage for storing the index number i of the random number table RND, which has been once used by the collator, wherein if the index number which has been already used, is reused when the collator compares and collates the function value f(RND[i]) next, after the power source has been turned off and then turned on again, the collator unconditionally judges that the function value f(RND[i]) does not coincide with the collating value G so that the storage device maintains the lock state.

In this case, if the index number i which has been already used is reused in the next comparison and collation, the portable storage device unconditionally maintains its lock state. That is, the usable index numbers i gradually decrease at every time that the collation is preformed. Therefore, if the hacking method (round-robin algorithm), in which many encryption keys are inputted lightly and repeatedly, is used, the usable index numbers i gradually decrease at every collation so that they will be used up sooner or later. Thus, illegal access using the round-robin algorithm may be surely prevented.

In the portable storage device, it is preferable that the random number table RND can be rewritten by the terminal device when the storage device maintains the free state thereof, while the index storage clears the index numbers i stored therein so as to make all of the index numbers i become usable if the random number table RND is rewritten.

In this case, because all of the index numbers i become usable again when the random number table RND is rewritten by the terminal device, the index numbers i can be restored when the index numbers i decreases due to proper access operations. In consequence, the operational property of the portable storage device may become good.

In the portable storage device, it is preferable that the function f can be changed by the terminal device when the storage device maintains the free state thereof. In this case, because the function f can be arbitrary changed in the free state, it may become more difficult to make the function value f(RND[i]) coincide with the collating value G by means of illegal access. In consequence, illegal access may be more surely prevented.

In the portable storage device, it is preferable that it further includes a code storage for storing a unique identification code UID, wherein the unique identification code UID having an arbitrary value can be written in the code storage by the terminal device when the storage device maintains the free state thereof, while the unique identification code UID which has been once written in the code storage, can be read by the terminal device even if the storage device maintains the lock state thereof.

In this case, when the random number table RND or the function f is changed by the terminal device, the unique identification code UID can be used as a key to make the database include such information that what a random number table RND or function f has been set to what a portable storage device by the terminal device.

In the portable storage device, it is preferable that for a plurality of combinations each of which is composed of an index number i and a collating value G supplied by the terminal device, the collator compares and collates the respective function value f(RND[i]) with the respective collating values G, while the storage device becomes the free state when the respective function value f(RND[i]) coincides with the respective collating value G for all of the combinations.

In this case, because the portable storage device becomes the free state when the respective function value f(RND[i]) coincides with the respective collating value G for all of the combinations, illegal access to the portable storage device may be more surely prevented.

### BRIEF DESCRIPTION OF THE DRAWINGS

Various characteristics and advantages of the present invention will become clear from the following description taken in conjunction with the preferred embodiments with reference to the accompanying drawings throughout which like parts are designated by like reference numerals, in which:

FIG. 1 is a block diagram showing a system configuration of a portable storage device (card) according to the present invention;

FIG. 2 is a view showing a data structure in the storage (memory block) of card type shown in FIG. 1;

FIG. 3 is a diagram showing a state transition in the card shown in FIG. 1;

FIG. 4 is a flowchart showing a process by means of authentication protocol according to Embodiment 1 of the present invention; and

FIG. 5 is a flowchart showing a process by means of authentication protocol according to Embodiment 2 of the present invention.

### DETAILED DESCRIPTION OF THE PREFERRED EMBODIMENTS

Hereinafter, preferred embodiments of the present invention will be concretely described.

(Embodiment 1)

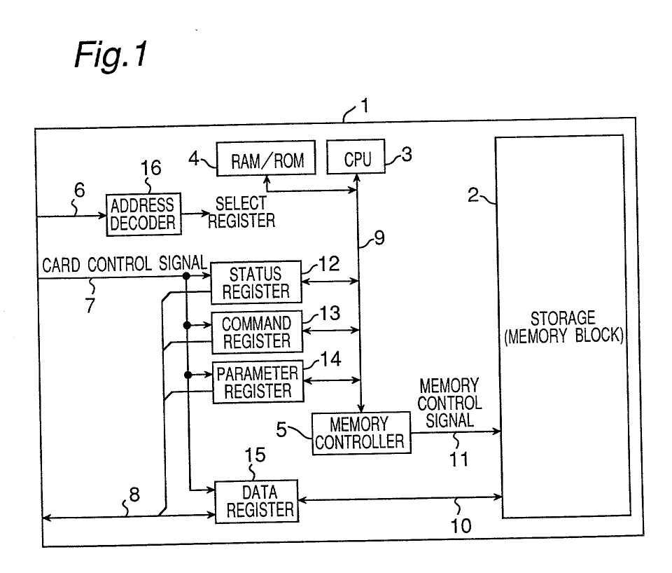

FIG. 1 is a block diagram of a portable storage device according to Embodiment 1 of the present invention. Regarding to FIG. 1, the general configuration or hardware configuration of the portable storage device is founded on a conventional technique which is found in, for example an ATA card or the like. Therefore, in FIG. 1, the detailed description of the general configuration is omitted so that characteristic aspects of the portable storage device, which are required for describing the present invention, are shown in the main.

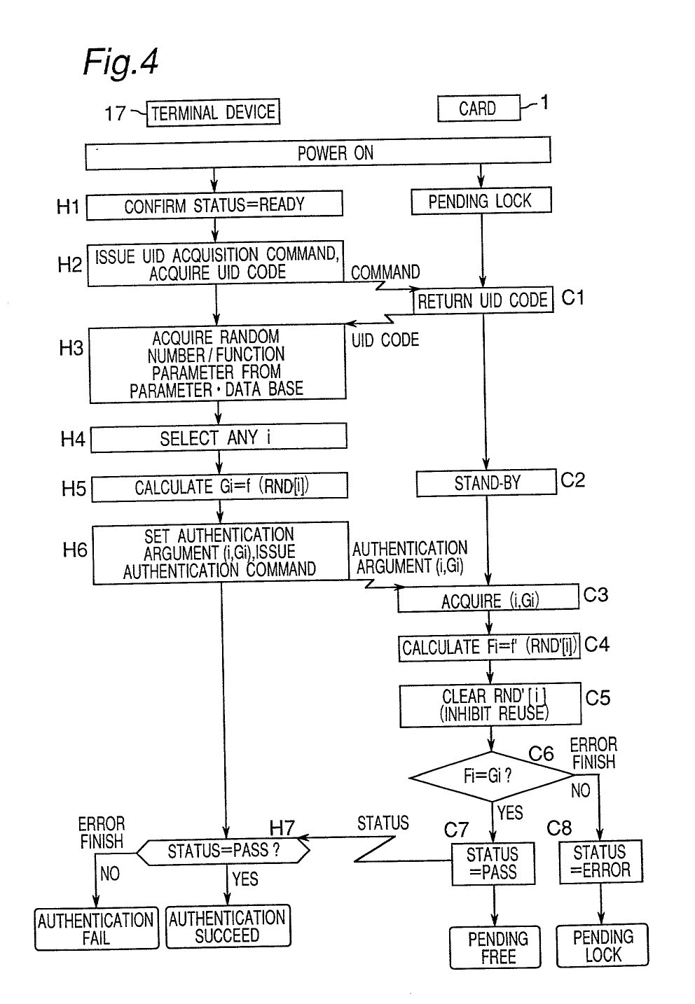

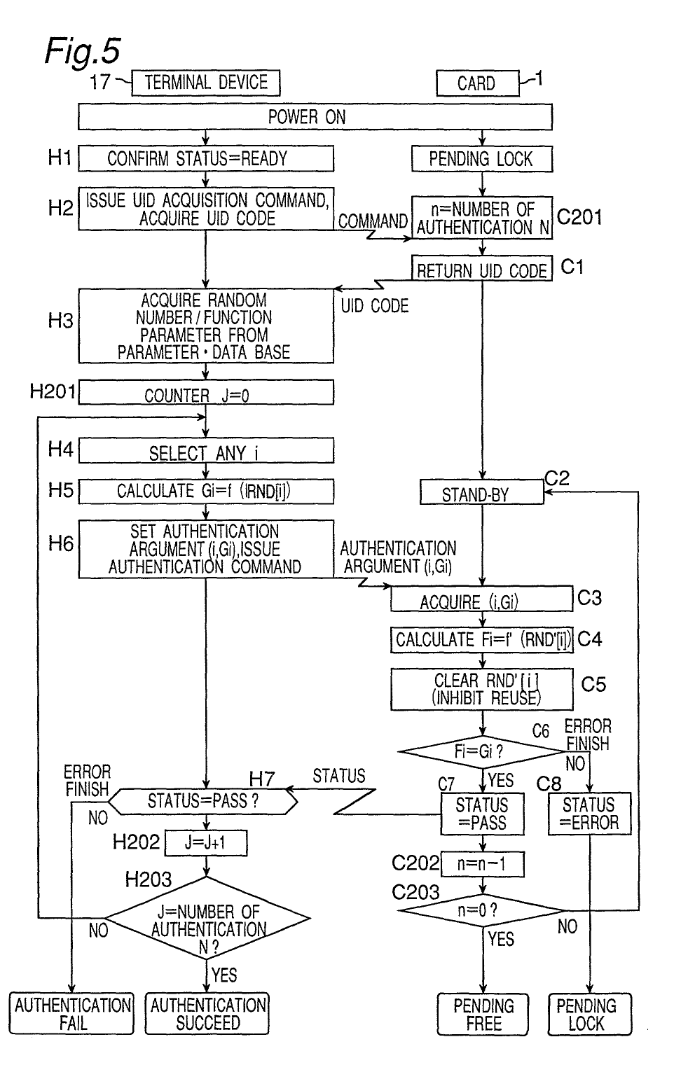

As shown in FIG. 1, the portable storage device 1 (referred to “card 1” hereinafter) is provided with a storage 2 for storing bulk data (referred to “memory 2” or “memory block 2” hereinafter), a CPU 3 (CPU block) for controlling the internal section of the card 1, a RAM/ROM 4 for storing an operation program for the CPU 3 and a memory controller 5 for generating a control signal which is required to access the memory 2. Thus, the card 1 can be connected to a terminal device 17 (see FIGS. 4 and 5) through a card address bus 6, a card control signal line 7 and a card data bus 8.

The terminal device 17 can read/write a status register 12, a command register 13, a parameter register 14 and a data register 15 through the card address bus 6, the card control signal line 7 and the card data bus 8. Thus, the terminal device 17 can access the card 1 through the registers 12-15. Hereupon, the CPU 3, the RAM/ROM 4, the memory controller 5 and the registers 12-14 are connected to one another through a CPU bus 9. The memory 2 is connected to the data register 15 through the memory data bus 10 while connected to memory controller 5 through a memory control signal line 11. The card address bus 6 is connected to the address decoder 16 for performing register allocation.

When the terminal device 17 sets a parameter to the parameter register 14 and writes a command to the command register 13, the CPU 3 reads the command register 13 and the parameter register 14 and then executes the predetermined processing in accordance with the command. Whether the processing of the command normally finished or erroneously finished can be judged by reading the status register 12. The data in the memory 2 can be accessed through the data register 15.

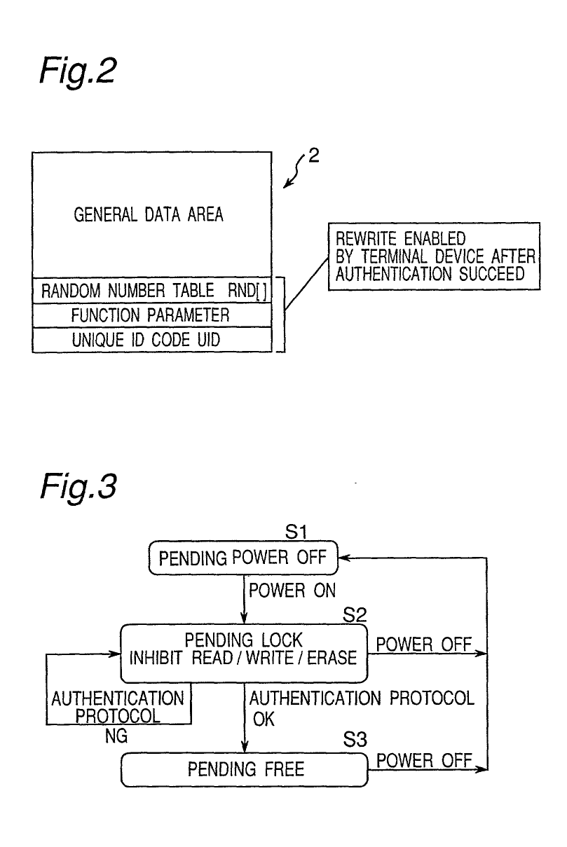

FIG. 2 shows the configuration of areas for storing data which are required for the authentication protocol stored in the nonvolatile memory 2 (memory block 2) of the card 1 according to the present invention. As shown in FIG. 2, in the memory 2, there is provided a general data area for storing general data, a random number table area for storing an array of random numbers RND or RND[ ] (referred to “random number table RND” hereinafter), a function parameter area for storing function parameters and a unique ID code area for storing unique ID codes UID (shortly referred to “UID code(s)” hereinafter).

The random number table RND is stored in a form of an array, wherein when an index number i is designated, a random number RND[i] is referenced. The function parameters are required for determining the function f or f( ). The terminal device 17, which can succeed the authentication, is limited to a terminal device having the random number table RND and the function f which are identical to those of the card 1, respectively. After succeeding the authentication, the random number table RND and the function parameters can be rewritten by the terminal device 17.

It is possible to make the card 1 have a UID code, in order to manage that any card 1 has what sort of a random number table RND and a function f in the terminal device 17 side when the random number table RND and the function parameters have been rewritten. In the case that the terminal device 17 has a database of the random number table RND and the function parameters corresponding to the UID code of the card 1, when another card 1 is inserted to the terminal device 17, the card can be authenticated if its UID code exists in the database.

Hereupon, as the above-mentioned function f, for example, an arithmetic function or a combination of arithmetic functions may be used. Alternatively, the function f may be such one performing a bit operation for an argument D such as, for example a cyclic code operation for the argument D or the like.

FIG. 3 is a state transition diagram of a functional operation for preventing illegal access for the card 1 according to the present invention. As shown in FIG. 3, in the card 1, the power source is shut in the state of pending power OFF (S1) so that the card 1 does not perform any operation. Then if the power source is turned on, the state is turned to a lock state (S2). In the card 1, a read operation (read access), a write operation (write access) and an erase operation (erase access) for the data in the memory 2 are inhibited in the lock state.

If the authentication is succeeded (OK) when the authentication protocol according to the present invention is performed in the lock state, the card 1 is turned to a free state (S3). In that case, it becomes possible to access the data in the memory 2, while it becomes to possible to rewrite the random number table, the function parameters or the UID code. If the authentication is failed (NG) when the authentication protocol is performed, the card 1 maintains its lock state. In Embodiment 1, the control of the state transition is achieved by means the abovementioned operation program executed by the CPU 3. Hereupon, if the power source is turned off when the card 1 maintains its lock state (S2) or its free state (S3), the state of the card 1 is returned to the state of pending power OFF (S1).

FIG. 4 shows a flowchart of processing operations of both of the card 1 and the terminal device 17 by means of the authentication protocol according to Embodiment 1. Hereinafter, the concrete processing operations of both of the card 1 and the terminal device 17 will be described with reference to FIG. 4. According to the authentication protocol, the card 1 becomes a lock state when the power source is turned on, and then waits a command. On the other hand, the terminal device 17 immediately starts to operate when the power source is turned on.

Thus, in the terminal device 17, the status of the card 1 is confirmed in Step H1. That is, it is confirmed whether the card 1 can accept the command or not. If the status of the card 1 is ready (i.e. card acceptable), the terminal device 17 sends the command to the card 1, and then reads the UID code. The card 1 returns the UID code to the terminal device 17 in response to the command (Step C1), whereby the card 1 becomes a stand-by state (Step C2). Following that, in Step H3, the terminal device 17 retrieves the database of the random number table RND and the function parameters on the basis of the obtained UID code, and then prepares the function f and the random number table RND identical to that possessed by the card 1, whereby the preparation of the authentication has been completed.

Next, in Step H4, an arbitrary index number i is selected from the random number table RND so that a random number RND[i] is obtained. Then, in Step H5, the function value of the function f, whose argument is set to the random number RND[i], is calculated so that the function value is defined as a collating value Gi (Gi=f(RND[i])). Hereupon, the pair (i.e. combination) of (i, Gi) becomes an authentication argument. Following that, in Step H6, the authentication argument (i,Gi) is set to the parameter register 14, while the authentication command is set to the command register 13. Then, the card 1 starts to perform the authentication processing.

Thus, in Step C3, the card 1 acquires authentication argument (i,Gi) from the parameter register 14. Following that, in Step C4, the card 1 calculates a function value Fi (=f′ (RND′[i])) on the basis of the function f′ and the random table RND′ possessed thereby. Further, in Step C5, the card 1 clears (deletes) the random number RND′[i] corresponding to the index number i from the random number table RND′. In consequence, if the index number i, which has been once used, is used in the following (next) authentication, the authentication is to be necessarily failed.

Further, in Step C6, the collating value Gi supplied from the terminal device 17 to the card 1 is compared with the function value Fi calculated by the card 1. If the terminal device 17 is such one to be authenticated, it becomes RND[i]=RND′[i] and f=f′ so that it must become Fi=Gi. If the function value Fi coincides with the collating value Gi (YES), the status is provided with a PASS code (Step C7). On the other hand, if the function value Fi does not coincide with the collating value Gi (NO), the status is provided with an ERROR code (Step C8). Then the status is returned to the terminal device 17 (Steps C7 and C8). Hereupon, if the status is PASS, then the card 1 becomes the free state. Meanwhile, if the status is ERROR, the card 1 maintains its lock state.

On the other hand, in Step H7, the terminal device 17 finds out the result of the authentication by confirming the status of the card 1. If the card 1 is under the free state, the random number table RND, the function parameters and the UID code can be rewritten. Meanwhile, regarding to the random number table, the random number RND[i] corresponding to the index number, which has been once used, can never be used. However, if the random number table RND is rewritten, all of the index numbers i can be used in the following authentication.

Hereinafter, there will be described functions or advantages of the card 1 according to Embodiment 1 of the present invention. In the authentication according to the present invention, the random number table RND and the function f are keys for security. Because outsiders cannot find out the random number table RND and the function f, the lock state cannot be illegally dissolved. In addition, the designation of the random number by the terminal device 17 is performed by means of the index number i, the outsider cannot find out even the bit length of the random number. Therefore, the data, which anticipate the form of the function f or the random number table RND, are not leaked out at all so that it may be also impossible to analogize those.

Moreover, if the index number i, which has been once used, is used again, the authentication is to be necessarily failed. In consequence, if the outsiders try to analyze the procedure by means of the hacking process, which monitors the interface signals, so as to obtain the authentication using the same procedure, they will fail to obtain the authentication. Meanwhile, if the hacking method, in which many encryption keys are inputted lightly and repeatedly, is used, the usable index numbers i gradually decrease at every trial. Thus, because the usable index numbers will be used up sooner or later, the outsider cannot infinitely repeat the trial so that they will fail to obtain the authentication. As described above, according to Embodiment 1 of the present invention, illegal access to the card 1 can be surely prevented.

As mentioned before, U.S. Pat. No. 6,126,071 also discloses a portable storage device which intends to prevent illegal access thereto, using (k,f(k)) as the authentication argument. In this conventional portable storage device, “k” which is arbitrarily selected by the terminal device corresponds to the random number RND[i] in Embodiment 1 according to the present invention. However, in Embodiment 1, the random number itself is not directly supplied to the card 1, but the random number is supplied through the index number so that the random number is not directly outputted outward. In consequence, in the card 1 (portable storage device) according to Embodiment 1, it is prevented that the random number is illegally dissolved or analogized. Further, in the card 1 according to Embodiment 1, because it is inhibited that the same index number is reused, trials of illegal access by means of the monitoring method or the round-robin algorithm may be prevented. Accordingly, functions which can firmly prevent illegal access may be achieved so that high security may be obtained.

(Embodiment 2)

Hereinafter, Embodiment 2 of the present invention will be described. However, because the fundamental construction of the portable storage device (card) according to Embodiment 2 is common with that of the portable storage device (card) according to Embodiment 1, differences between Embodiments 1 and 2 will be mainly described hereinafter in order to avoid duplicate descriptions.

As described above, according to Embodiment 1, the collation of the authentication argument (i,Gi) is performed only once. On the other hand, according to Embodiment 2, the collation of the authentication argument (i,Gi) is performed plural times. That is the substantial difference between Embodiments 1 and 2. The other matters regarding to Embodiment 2 are substantially identical to those of Embodiment 1.

FIG. 5 shows a flowchart of processing operations of both of the card 1 and the terminal device 17 by means of the authentication protocol according to Embodiment 2. Hereinafter, the concrete processing operations of both of the card 1 and the terminal device 17 will be described with reference to FIG. 5. However, in FIG. 5, the steps common with those of the flowchart shown in FIG. 4 according to Embodiment 1 are given the same step numbers as those in FIG. 4, and further descriptions about those steps are omitted.

As shown in FIG. 5, the flowchart according to Embodiment 2 is identical to the flowchart shown in FIG. 4, to which Steps H201, H202 and H203 as the processing at the terminal device 17 side and Steps C201, C202 and C203 as the processing at the card 1 side have been added.

Thus, as the processing at the terminal device 17 side, in Step H201, a collation counter J for controlling the iterative processing of the authentication is initialized (J=0). In Step H202, the collation counter J is incremented by 1 (J=J+1). Meanwhile, in Step H203, it is judged whether the collation counter J reaches N, which is the number of times required for the authentication.

On the other hand, as the processing at the card 1 side, in Step C201 executed immediately after the power source has been turned on, a collation flag n is initialized (n=N). Hereupon, N means the number of times required for the authentication by the collation counter J. In Step C202, the collation flag n is decremented by 1 (n=n−1). Meanwhile, in Step C203, it is judged whether the collation flag n is 0 or not, that is whether the status is wholly PASS in each of the N times of collating operations or not. If n is equal to zero (YES), the card 1 becomes the free state because the authentication is succeeded (OK). On the other hand, n is not equal to zero (NO), the collation is continued because further collating operations are required yet.

As described above, according to Embodiment 2, because the collating operations according to Embodiment 1 is repeated plural times (N times), illegal access to the card 1 may be more surely prevented.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A portable storage device with a function for preventing illegal access thereto, which fills functions thereof when connected to a terminal device, said portable storage device comprising:
an array storage for storing a random number array RND;
a calculator for calculating a function value f(RND[i]) of a preset function f by setting an argument of said function f as a random number RND[i] corresponding to an index number which is designated from the random number array RND by said terminal device; and
a collator for comparing and collating the function value f(RND[i]) with a collating value G which is supplied by said terminal device.

2. The portable storage device according to claim 1, which initially becomes such a lock state that read access, write access and erase access for said storage device are inhibited, after a power source has been turned on, wherein
said storage device becomes such a free state that the read access, the write access and the erase access for said storage device are permitted if the function value f(RND[i]) coincides with the collating value G, while said storage device maintains the lock state if the function value f(RND[i]) does not coincide with the collating value G.

3. The portable storage device according to claim 2, further comprising an index storage for storing the index number i of the random number array RND, which has been once used by said collator, wherein
if the index number which has been already used, is reused when said collator compares and collates the function value f(RND[i]) next, after the power source has been turned off and then turned on again, said collator unconditionally judges that the function value f(RND[i]) does not coincide with the collating value G so that said storage device maintains the lock state.

4. The portable storage device according to claim 3, wherein the random number array RND can be rewritten by said terminal device when said storage device maintains the free state thereof, while said index storage clears the index numbers i stored therein so as to make all of the index numbers i become usable if the random number array RND is rewritten.

5. The portable storage device according to claim 4, wherein said function f can be changed by said terminal device when said storage device maintains the free state thereof.

6. The portable storage device according to claim 4, further comprising a code storage for storing a unique identification code UID, wherein said unique identification code UID having an arbitrary value can be written in said code storage by said terminal device when said storage device maintains the free state thereof, while said unique identification code UID which has been once written in said code storage, can be read by said terminal device even if said storage device maintains the lock state thereof.

7. The portable storage device according to claim 4, wherein for a plurality of combinations each of which is composed of an index number i and a collating value G supplied by said terminal device, said collator compares and collates the respective function value f(RND[i]) with the respective collating values G, while said storage device becomes the free state when the respective function value f(RND[i]) coincides with the respective collating value G for all of the combinations.
